(19) United States
(12) Patent Application Publication
(10) Pub. No.: US 2016/0180035 A1
(43) Pub. Date: Jun. 23, 2016

(54) SYSTEMS AND METHODS FOR MINIMIZING REVENUE LEAKAGE BY IMPROVING COMORBIDITY CODING AND LOWERING THE MORTALITY INDEX WHILE INCREASING INPATIENT REVENUE

(71) Applicants: David Maughan, Lindon, UT (US); Reed Barney, Lindon, UT (US); Russell Vinik, Lindon, UT (US); John Arego, Lindon, UT (US); Elton Barry, Lindon, UT (US)

(72) Inventors: David Maughan, Lindon, UT (US); Reed Barney, Lindon, UT (US); Russell Vinik, Lindon, UT (US); John Arego, Lindon, UT (US); Elton Barry, Lindon, UT (US)

(21) Appl. No.: 14/961,712

(22) Filed: Dec. 7, 2015

Related U.S. Application Data
(60) Provisional application No. 62/094,475, filed on Dec. 19, 2014.

(51) Int. Cl. G06F 19/00

(52) U.S. Cl. CPC G06F 19/328; G06F 19/322; G06F 19/3443

(57) ABSTRACT

Systems and methods for reducing revenue leakage involve identifying from a database containing information regarding treatment of a patient by a medical services provider and conducting a keyword search within the database based on keywords commonly associated with billable services. When a keyword of interest is located within the database, a data mining search of words preceding and following the located keyword of interest is conducted to identify any modifiers relevant to the located keyword of interest. Then, the located keyword and any identified modifiers are used to identify one or more unbilled services, and action is taken to facilitate billing of the one or more unbilled services. The ability to access data from multiple disparate data sources utilizing NLP, Virtual Machines and HL7 messaging will benefit the service provider by improving processes and training clinicians how to be more succinct and to find all appropriate opportunities to recognize revenue when costs have been incurred.

### CROSS-REFERENCE TO RELATED APPLICATIONS

This application claims the benefit of U.S. Provisional Patent Application No. 62/094,475 which was filed on Dec. 19, 2014.

### BACKGROUND OF THE INVENTION

1. Field of the Invention

The present invention relates to revenue leakage, and more particularly to systems and methods for minimizing revenue leakage occurring when a service provider fails to identify, capture, and bill, or properly bill for all services provided, by improving comorbidity coding and lowering the mortality index while increasing inpatient revenue.

2. Background and Related Art

In the medical services field, improper billing and failing to account properly for all services is believed to result in lost revenues of approximately one to three percent of all revenues. This can be a significant impact in an industry that may have a margin of only approximately three percent. Therefore, the problem of revenue leakage may result in a loss of as much of or even more than half of these service providers' profits.

Providers of medical services obtain revenues from a variety of sources. Revenue sources may include the recipients of the services themselves, insurance providers, Medicaid, and Medicare. The problem of revenue leakage can occur in association with any revenue source, and is particularly associated with obtaining revenues from revenue sources having complex rules for billing and reimbursement.

For example, health care providers seeking reimbursement through Medicare are required to use certain codes under the International Statistical Classification of Diseases and Related Health Problems, otherwise known as the International Classification of Diseases (ICD). The ICD is maintained by the World Health Organization (WHO) and is intended as a health care classification system providing a system of diagnostic codes for classifying diseases, including a variety of signs, symptoms, abnormal findings, complaints, social circumstances, and external causes of injury or disease. The ICD is revised periodically, and is currently on its tenth revision, with the eleventh revision slated for approximately 2017. Providers seeking Medicare reimbursement are required to use ICD codes, regardless of the size of the providers, and the complexity of ICD coding represents one source of revenue leakage: it is difficult for medical billing coders to properly translate medical records into ICD code equivalents to satisfy Medicare requirements.

The changing versions of the ICD create additional problems. Until recently, Medicare has utilized version 9 of the ICD. However, the Health Insurance Portability and Accountability Act (HIPAA) requires transition to ICD-10. The transition to ICD-10 is widely considered to be disruptive to providers of medical services, as they must change their billing practices to adopt the new codes. Where there were over 14,000 ICD-9 codes, each having 3-5 digits, there are approximately 68,000 ICD-10 codes that each have 3-7 characters. Thus, the adoption of ICD-10 codes will likely result in additional revenue leakage, especially as medical coders are in training to make the transition.

The transition has been more difficult due to uncertainties in the scheduled date of adoption of ICD-10 by Medicare. While originally scheduled for implementation earlier, opposition to earlier implementation resulted in passage of the Protecting Access to Medicare Act of 2014, which pushed back implementation of ICD-10 by Medicare to no earlier than Oct. 1, 2015. Recently promulgated agency rules currently indicate that the date of implementation will be Oct. 1, 2015, but a possibility remains that the implementation date will change again.

Regardless of the version of ICD being used, if a medical coder fails to identify the proper clinical documentation, fails to input a correct code, or fails to input all codes associated with medical services provided by the medical service provider, additional revenue leakage may occur. For example, if a coder misses a note on a patient's chart, an ICD code will be missed. The health services provider therefore misses out on revenue that it could have otherwise obtained.

Others involved in the provision and documentation of health services may similarly be sources of revenue leakage. For example, if a physician or nurse fails to note every procedure performed or medication administered to a patient on the patient's chart or other record, there is little chance that the coder will be able to properly input proper ICD codes to permit full reimbursement for the services performed.

Problems leading to revenue leakage are complex and may originate from a variety of sources. As a result, the search for solutions to the problem of revenue leakage has been similarly complex and has generally been inadequate to address the problem.

### BRIEF SUMMARY OF THE INVENTION

Implementation of the invention provides systems, methods and non-transitory computer-readable medium containing computer program code means for executing computer-implemented methods for reducing revenue leakage. An exemplary method may include steps of accessing a revenue-related database (and/or all revenue- and non-revenue-related databases, data sources, documents and/or other electronic files that may be mined to identify lost opportunities) containing information regarding treatment of a patient by a medical services provider, conducting a keyword search within the database based on keywords commonly associated with diagnosis-related groups (DRGs) and keywords potentially implicating DRGs, and locating a keyword of interest within the database (and/or other disparate databases, data sources, documents and/or other electronic files). The treatment may include a diagnosis or a procedure relating to or leading to a diagnosis, a procedure performed, a medication administered, or any other service provided by medical service providers. The exemplary method may also include conducting a data mining search of words preceding and following the located keyword of interest to identify any modifiers relevant to the located keyword of interest, using the located keyword and any identified modifiers to identify one or more unbilled DRGs associated with the treatment of the patient that has not been billed for by the medical services provider, and taking an action to facilitate identifying, capturing, and billing of services associated with the one or more unbilled DRGs.

Taking an action to facilitate identifying, capturing, and billing of services associated with the one or more unbilled DRGs may include steps of using information in the database to confirm that services associated with the unbilled DRG were performed and billing for the performed services associated with the unbilled DRG. Alternatively, taking an action to facilitate identifying, capturing, and billing of services associated with the one or more unbilled DRGs may include generating an electronic communication to the medical services provider requesting clarification of whether services associated with the unbilled DRGs were performed and sending the electronic communication to the medical services provider. The electronic communication may take any desirable form, including text or multimedia messages, emails, and proprietary system communications, such as communications within an electronic medical record system.

The electronic communication may include information identifying services associated with the one or more unbilled DRGs. The electronic communication may alternatively include identification of the patient, a date or date range of treatment, and information about one or more treatments known to have been performed, along with identification of one or more treatments commonly performed with the one or more treatments known to have been performed and a request that the provider review whether the one or more treatments commonly performed was performed with the one or more treatments known to have been performed.

The electronic communication may alternatively include identification of the patient, a date or date range of treatment, and information about one or more diagnoses known to have been identified by the medical services provider, along with identification of one or more diagnoses or treatments commonly performed in conjunction with or identified with the one or more diagnoses known to have been identified by the medical services provider and a request that the provider review whether the one or more diagnoses or treatments commonly performed was identified or performed with the one or more diagnoses known to have been identified by the medical services provider. The electronic communication may alternatively include identification of a treatment known to have been performed or a diagnosis known to have been identified by the medical services provider and identification of one or more complications and comorbid conditions (CCs) or major complications and comorbid conditions (MCCs) commonly known to occur in conjunction with the treatment known to have been performed or the diagnosis known to have been identified by the medical services provider.

In implementations of the exemplary method, using the located keyword and any identified modifiers to identify one or more unbilled DRGs associated with the treatment of the patient that has not been billed for by the medical services provider may include identifying one or more CCs or MCCs commonly known to occur in conjunction with the keyword of interest and any identified modifiers and identifying unbilled DRGs associated with any identified CCs or MCCs. The method may be adapted to be conducted behind a firewall to comply with any requirements of HIPAA and to prevent unauthorized disclosure of confidential medical information.

An identified modifier may be used to perform an action such as identifying a CC associated with a diagnosis reached or treatment performed by the medical services provider, identifying an MCC associated with a diagnosis reached or treatment performed by the medical services provider, eliminating a CC not associated with a diagnosis reached or treatment performed by the medical services provider, eliminating an MCC not associated with a diagnosis reached or treatment performed by the medical services provider, identifying a DRG associated with a diagnosis reached or treatment performed by the medical services provider, and eliminating a DRG not associated with a diagnosis reached or treatment performed by the medical services provider.

According to another exemplary method for reducing revenue leakage, the method may include steps of accessing a revenue-related database containing electronic medical records of treatment of a patient by a medical services provider (and/or accessing all revenue- and non-revenue-related databases, data sources, documents and/or other electronic files that may be mined to identify lost opportunities), conducting an automated keyword search within the database based on one or more keywords commonly associated with DRGs or potentially implicating DRGs, locating a keyword of interest within the database (and/or other disparate databases, data sources, documents and/or other electronic files), and conducting a data mining search of words preceding and following the located keyword of interest to identify any modifiers relevant to the located keyword of interest. The method may also include steps of using the located keyword and any identified modifiers to identify one or more unbilled DRGs associated with the treatment of the patient that may potentially be billed for by the medical services provider, and taking an action to confirm that the unbilled DRG can be billed by the medical services provider.

Taking an action to confirm that the unbilled DRG can be billed by the medical services provider may include using information in the database to confirm that services associated with the unbilled DRG were performed, and billing for the performed services associated with the unbilled DRG. Alternatively, taking an action to confirm that the unbilled DRG can be billed by the medical services provider may include generating an electronic communication to the medical services provider requesting clarification of whether services associated with the unbilled DRGs were performed and sending the electronic communication to the medical services provider.

The electronic communication may include information identifying services associated with the one or more unbilled DRGs. The electronic communication may include identification of the patient, a date or date range of treatment, and information about one or more treatments known to have been performed, along with identification of one or more treatments commonly performed with the one or more treatments known to have been performed and a request that the provider review whether the one or more treatments commonly performed was performed with the one or more treatments known to have been performed.

The electronic communication may alternatively include identification of the patient, a date or date range of treatment, and information about one or more diagnoses known to have been identified by the medical services provider, along with identification of one or more diagnoses or treatments commonly performed in conjunction with or identified with the one or more diagnoses known to have been identified by the medical services provider and a request that the provider review whether the one or more diagnoses or treatments commonly performed was identified or performed with the one or more diagnoses known to have been identified by the medical services provider. Alternatively, the electronic communication may include identification of a treatment known to have been performed or a diagnosis known to have been identified by the medical services provider, and identification of one or more CCs or MCCs commonly known to occur in conjunction with the treatment known to have been performed or the diagnosis known to have been identified by the medical services provider.

Using the located keyword and any identified modifiers to identify one or more unbilled DRGs associated with the treatment of the patient that may potentially be billed for by the medical services provider may include steps of identifying one or more CCs or MCCs commonly known to occur in conjunction with the keyword of interest and any identified modifiers and identifying unbilled DRGs associated with any identified CCs or MCCs. The method may be adapted to be conducted behind a firewall to comply with any requirements of HIPAA and to prevent unauthorized disclosure of confidential medical information.

An identified modifier may be used to perform an action such as identifying a CC associated with a diagnosis reached or treatment performed by the medical services provider, identifying a MCC associated with a diagnosis reached or treatment performed by the medical services provider, eliminating a CC not associated with a diagnosis reached or treatment performed by the medical services provider, eliminating an MCC not associated with a diagnosis reached or treatment performed by the medical services provider, identifying a DRG associated with a diagnosis reached or treatment performed by the medical services provider, and eliminating a DRG not associated with a diagnosis reached or treatment performed by the medical services provider.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a representative computer system for use with embodiments of the invention;

FIG. 2 shows a representative networked computer system for use with embodiments of the invention; and

FIG. 3 shows a representative method in accordance with embodiments of the invention.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide systems, methods and non-transitory computer-readable medium containing computer program code means for executing computer-implemented methods for reducing revenue leakage. An exemplary method may include steps of accessing a revenue-related database (and/or all revenue- and non-revenue-related databases, data sources, documents and/or other electronic files that may be mined to identify lost opportunities) containing information regarding treatment of a patient by a medical services provider, conducting a keyword search within the database based on keywords commonly associated with diagnosis-related groups (DRGs) and keywords potentially implicating DRGs, and locating a keyword of interest within the database (and/or other disparate databases, data sources, documents and/or other electronic files). The treatment may include a diagnosis or a procedure relating to or leading to a diagnosis, a procedure performed, a medication administered, or any other service provided by medical service providers. The exemplary method may also include conducting a data mining search of words preceding and following the located keyword of interest to identify any modifiers relevant to the located keyword of interest, using the located keyword and any identified modifiers to identify one or more unbilled DRGs associated with the treatment of the patient that has not been billed for by the medical services provider, and taking an action to facilitate identifying, capturing, and billing of services associated with the one or more unbilled DRGs.

Taking an action to facilitate identifying, capturing, and billing of services associated with the one or more unbilled DRGs may include steps of using information in the database to confirm that services associated with the unbilled DRG were performed and billing for the performed services associated with the unbilled DRG. Alternatively, taking an action to facilitate identifying, capturing, and billing of services associated with the one or more unbilled DRGs may include generating an electronic communication to the medical services provider requesting clarification of whether services associated with the unbilled DRGs were performed and sending the electronic communication to the medical services provider. The electronic communication may take any desirable form, including text or multimedia messages, emails, and proprietary system communications, such as communications within an electronic medical record system.

The electronic communication may include information identifying services associated with the one or more unbilled DRGs. The electronic communication may alternatively include identification of the patient, a date or date range of treatment, and information about one or more treatments known to have been performed, along with identification of one or more treatments commonly performed with the one or more treatments known to have been performed and a request that the provider review whether the one or more treatments commonly performed was performed with the one or more treatments known to have been performed.

The electronic communication may alternatively include identification of the patient, a date or date range of treatment, and information about one or more diagnoses known to have been identified by the medical services provider, along with identification of one or more diagnoses or treatments commonly performed in conjunction with or identified with the one or more diagnoses known to have been identified by the medical services provider and a request that the provider review whether the one or more diagnoses or treatments commonly performed was identified or performed with the one or more diagnoses known to have been identified by the medical services provider. The electronic communication may alternatively include identification of a treatment known to have been performed or a diagnosis known to have been identified by the medical services provider and identification of one or more complications and comorbid conditions (CCs) or major complications and comorbid conditions (MCCs) commonly known to occur in conjunction with the treatment known to have been performed or the diagnosis known to have been identified by the medical services provider.

In embodiments of the exemplary method, using the located keyword and any identified modifiers to identify one or more unbilled DRGs associated with the treatment of the patient that has not been billed for by the medical services provider may include identifying one or more CCs or MCCs commonly known to occur in conjunction with the keyword of interest and any identified modifiers and identifying unbilled DRGs associated with any identified CCs or MCCs. The method may be adapted to be conducted behind a firewall to comply with any requirements of the HIPAA and to prevent unauthorized disclosure of confidential medical information.

An identified modifier may be used to perform an action such as identifying a CC associated with a diagnosis reached or treatment performed by the medical services provider, identifying an MCC associated with a diagnosis reached or treatment performed by the medical services provider, eliminating a CC not associated with a diagnosis reached or treatment performed by the medical services provider, eliminating an MCC not associated with a diagnosis reached or treatment performed by the medical services provider, identifying a DRG associated with a diagnosis reached or treatment performed by the medical services provider, and eliminating a DRG not associated with a diagnosis reached or treatment performed by the medical services provider.

According to another exemplary method for reducing revenue leakage, the method may include steps of accessing a revenue-related database containing electronic medical records of treatment of a patient by a medical services provider (and/or accessing all revenue- and non-revenue-related databases, data sources, documents and/or other electronic files that may be mined to identify lost opportunities), conducting an automated keyword search within the database based on one or more keywords commonly associated with DRGs or potentially implicating DRGs, locating a keyword of interest within the database (and/or other disparate databases, data sources, documents and/or other electronic files), and conducting a data mining search of words preceding and following the located keyword of interest to identify any modifiers relevant to the located keyword of interest. The method may also include steps of using the located keyword and any identified modifiers to identify one or more unbilled DRGs associated with the treatment of the patient that may potentially be billed for by the medical services provider, and taking an action to confirm that the unbilled DRG can be billed by the medical services provider.

Taking an action to confirm that the unbilled DRG can be billed by the medical services provider may include using information in the database to confirm that services associated with the unbilled DRG were performed, and billing for the performed services associated with the unbilled DRG. Alternatively, taking an action to confirm that the unbilled DRG can be billed by the medical services provider may include generating an electronic communication to the medical services provider requesting clarification of whether services associated with the unbilled DRGs were performed and sending the electronic communication to the medical services provider.

The electronic communication may include information identifying services associated with the one or more unbilled DRGs. The electronic communication may include identification of the patient, a date or date range of treatment, and information about one or more treatments known to have been performed, along with identification of one or more treatments commonly performed with the one or more treatments known to have been performed and a request that the provider review whether the one or more treatments commonly performed was performed with the one or more treatments known to have been performed.

The electronic communication may alternatively include identification of the patient, a date or date range of treatment, and information about one or more diagnoses known to have been identified by the medical services provider, along with identification of one or more diagnoses or treatments commonly performed in conjunction with or identified with the one or more diagnoses known to have been identified by the medical services provider and a request that the provider review whether the one or more diagnoses or treatments commonly performed was identified or performed with the one or more diagnoses known to have been identified by the medical services provider. Alternatively, the electronic communication may include identification of a treatment known to have been performed or a diagnosis known to have been identified by the medical services provider, and identification of one or more CCs or MCCs commonly known to occur in conjunction with the treatment known to have been performed or the diagnosis known to have been identified by the medical services provider.

Using the located keyword and any identified modifiers to identify one or more unbilled DRGs associated with the treatment of the patient that may potentially be billed for by the medical services provider may include steps of identifying one or more CCs or MCCs commonly known to occur in conjunction with the keyword of interest and any identified modifiers and identifying unbilled DRGs associated with any identified CCs or MCCs. The method may be adapted to be conducted behind a firewall to comply with any requirements of HIPAA and to prevent unauthorized disclosure of confidential medical information.

An identified modifier may be used to perform an action such as identifying a CC associated with a diagnosis reached or treatment performed by the medical services provider, identifying a MCC associated with a diagnosis reached or treatment performed by the medical services provider, eliminating a CC not associated with a diagnosis reached or treatment performed by the medical services provider, eliminating an MCC not associated with a diagnosis reached or treatment performed by the medical services provider, identifying a DRG associated with a diagnosis reached or treatment performed by the medical services provider, and eliminating a DRG not associated with a diagnosis reached or treatment performed by the medical services provider.

In any example discussed herein referencing an action taken with respect to a single database (whether revenue-related or non-revenue-related), electronic file, document, or other data source, it should be understood that the same action may be simultaneously or serially taken with respect to any other data source of any similar or disparate type. The examples discussed herein are intended to be illustrative and instructive of the practice of embodiments of the invention, and are not intended to limit the scope of the claimed invention to the specific example indicated or to taking actions with respect to a single data source.

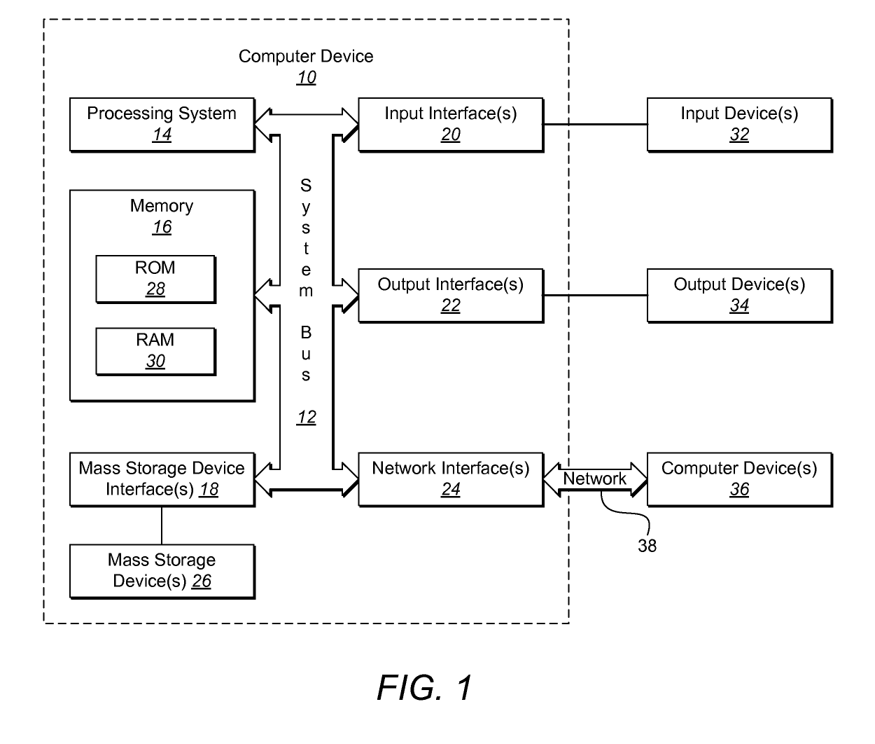

As embodiments of the invention are adapted for implementation using any of a variety of computer systems, FIG. 1 and the corresponding discussion are intended to provide a general description of a suitable operating environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook or laptop computer, a netbook, a personal digital assistant (“PDA”) or other hand-held device, a smart phone, a tablet computer, a workstation, a minicomputer, a mainframe, a supercomputer, a multi-processor system, a network computer, a processor-based consumer electronic device, a computer device integrated into another device or vehicle, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

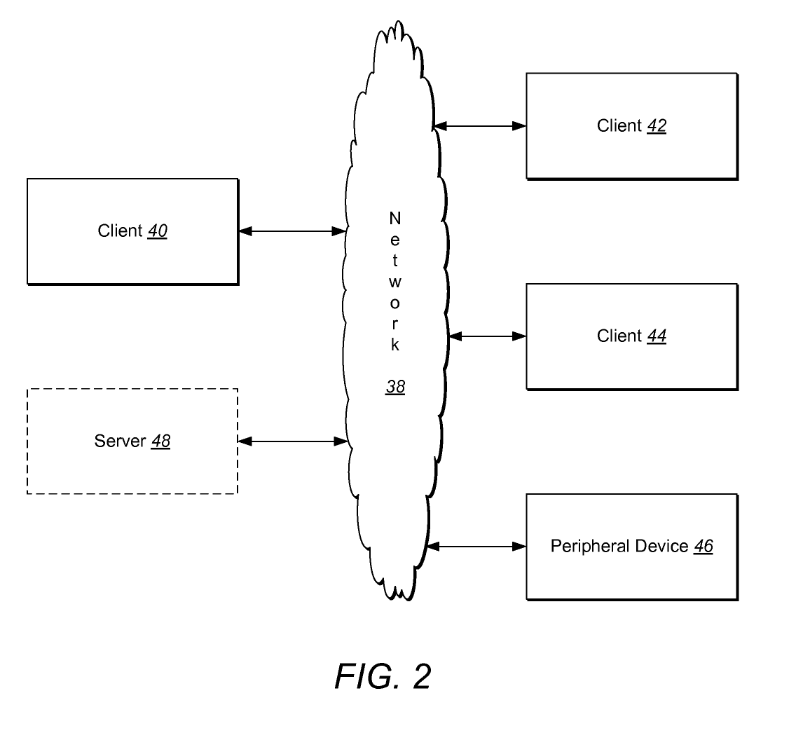

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a computer device, illustrated as client 40, which is connected to one or more other computer devices (illustrated as client 42 and client 44) and one or more peripheral devices 46 across network 38. While FIG. 2 illustrates an embodiment that includes a client 40, two additional clients, client 42 and client 44, one peripheral device 46, and optionally a server 48, which may be a print server, connected to network 38, alternative embodiments include more or fewer clients, more than one peripheral device, no peripheral devices 46, no server 48, and/or more than one server 48 connected to network 38. Other embodiments of the present invention include local, networked, or peer-to-peer environments where one or more computer devices may be connected to one or more local or remote peripheral devices. Moreover, embodiments in accordance with the present invention also embrace a single electronic consumer device, wireless networked environments, and/or wide area networked environments, such as the Internet.

Similarly, embodiments of the invention embrace cloud-based architectures where one or more computer functions are performed by remote computer systems and devices at the request of a local computer device. Thus, returning to FIG. 2, the client 40 may be a computer device having a limited set of hardware and/or software resources. Because the client 40 is connected to the network 38, it may be able to access hardware and/or software resources provided across the network 38 by other computer devices and resources, such as client 42, client 44, server 48, or any other resources. The client 40 may access these resources through an access program, such as a web browser, and the results of any computer functions or resources may be delivered through the access program to the user of the client 40. In such configurations, the client 40 may be any type of computer device or electronic device discussed above or known to the world of cloud computing, including traditional desktop and laptop computers, smart phones and other smart devices, tablet computers, or any other device able to provide access to remote computing resources through an access program such as a browser.

In light of privacy concerns and the protection of patient data, including compliance with the requirements of the HIPAA, embodiments of the invention may be implemented entirely within a secured health provider computer system. Thus embodiments of the invention may be implemented behind firewalls or other protective measures that prevent transmission of protected and confidential patient health data outside of the protected systems. In that light, it should be understood that the illustrative computer systems and networked computer systems illustrated in FIGS. 1 and 2 may represent protected computer systems and networks 38 that are in compliance with the concerns discussed above.

Under current practices, a medical provider's systems often contain a database (or multiple databases and/or electronic files or other data sources) of electronic medical records (EMRs) containing various information about the medical provider's patients. The database is typically stored on one or more (typically multiple redundant) mass storage devices 26 and/or servers 48. The electronic medical records are made available to employees of the medical provider (e.g. nurses, doctors, coders, etc.) who have a need to access and/or modify the electronic medical records. The electronic medical records may also be made available in a complete or partial form to medical billing coders to allow them to generate appropriate billing codes from the information in the electronic medical records. As discussed above, it is a common occurrence for a revenue leakage event or inpatient comorbidity billing opportunity to occur at some point in the process of generating and modifying electronic medical records, or at some point in the coding and billing process using the electronic medical records for medical services provided.

While revenue leakage events and inpatient comorbidity billing opportunities occur with some regularity even in the best of circumstances, such events only occur in a small percentage of cases, on the order of a few percent of instances. Attempts to manually locate errors leading to revenue leakage events and inpatient comorbidity billing opportunities have generally proven futile: the low occurrence rate effectively creates a situation where reviewers are seeking the proverbial needle in a haystack: multiple completely correct electronic medical records and coding efforts must be reviewed for each instance of an error located. Additionally, manual review often fails to identify revenue leakage events and inpatient comorbidity billing opportunities for the same reasons that led to the original revenue leakage events and inpatient comorbidity billing opportunities.

While efforts have been made to automate coding efforts, automatic billing coding systems often fail to identify and locate many types of revenue leakage events and inpatient comorbidity billing opportunities. Automatic coding systems fail to address instances where there are omissions or where errors are entered into the electronic medical records by employees of the medical provider (e.g. doctors or nurses).

Embodiments of the invention address the shortcomings of current systems and methods using automated free text searching of electronic medical records in conjunction with Boolean operator searches and natural language processing (NLP) techniques. The systems and methods discussed herein are able to independently identify instances where new billing codes are appropriate, and are further able to identify instances where targeted review of patients' electronic medical records and charts may lead to additional billing codes and associated revenue recovery or increased billing. Implementation of the embodiments of the invention will naturally lead to improvements in clinical documentation as employees of the medical provider interact with the system and begin to recognize instances where additional billing codes are warranted as well as instances where improved documentation of medical services provided will result in improved recovery of all possible revenues.

Embodiments of the invention may be utilized at any stage in the medical coding and billing process. For example, embodiments of the invention may be used in conjunction with or even prior to a first pass through the medical records for coding and billing. When used in this fashion, embodiments of the invention may be used to prevent revenue leakage from occurring in the first instance (as opposed to detecting potential revenue leakage for correction). Embodiments of the invention may be utilized in conjunction with manual and automated coding systems, methods, and procedures. Alternatively, embodiments of the invention may be utilized subsequent to a first effort at coding medical records for billing purposes, and may thus be used as a failsafe check to detect potential revenue leakage errors and events and inpatient comorbidity billing opportunities. Indeed, embodiments of the invention may be utilized at any point in time after medical services are provided to ensure that the medical provider is able to fully bill for services provided.

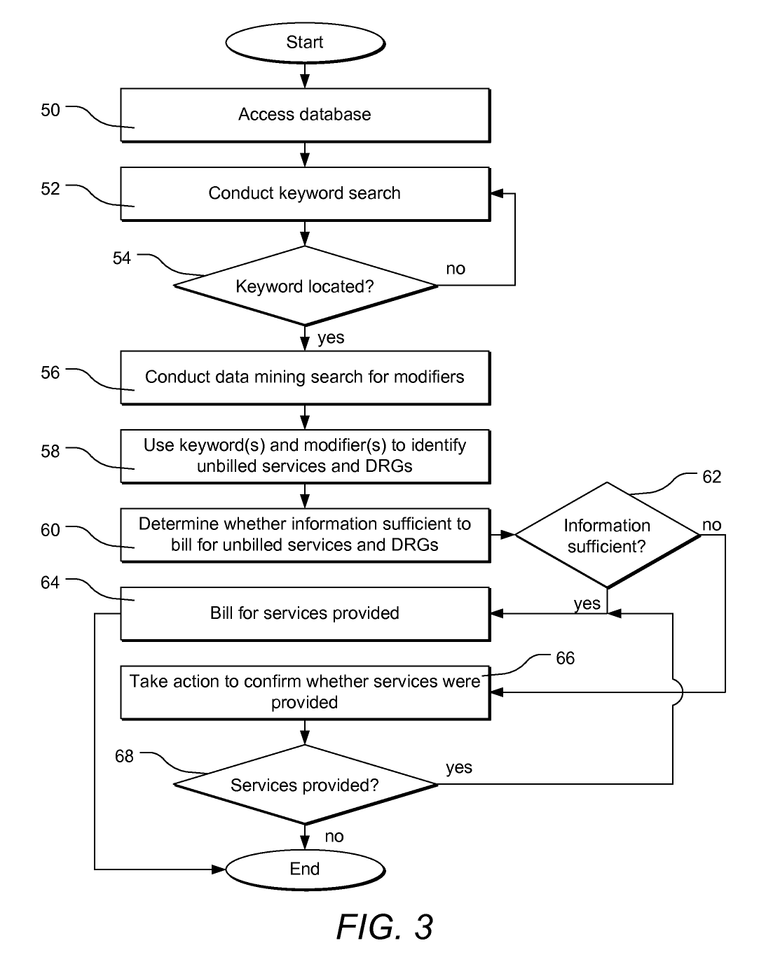

FIG. 3 illustrates an exemplary method in accordance with embodiments of the invention. While the example discussed herein with respect to FIG. 3 is discussed in relation to a provider of medical services, which encompasses hospitals, doctors offices, health systems, independent medical providers, and the like, regardless of size, it should be understood that the processes described may be appropriately adapted to any industry that suffers from revenue leakage problems, and is not necessarily limited to application to revenue leakage in the medical field. Instead, addressing the problem of revenue leakage is adequately illustrated by application to the medical field.

The method begins with step 50, where the system accesses a revenue-related database containing information regarding treatment of a patient by a medical services provider. While step 50 shows accessing a revenue-related database, the method may additionally or alternatively entail accessing a non-revenue-related database, or any other data source, electronic file, document, etc., and all references to the revenue-related database may be understood to additionally or alternatively refer to these alternative data sources. The revenue-related database may contain patients' entire electronic medical records, or it may contain less than entire medical records, such as containing only sufficient information to permit current coding operations of the electronic medical records for billing purposes (e.g. the information may be de-identified or otherwise protected to protect source medical records from unwarranted disclosure of confidential data).

At step 52, the system conducts a keyword search within the database of electronic medical records. The keyword search may include a free text search of all text within the electronic medical records. The search may be made on multiple keywords at once or iteratively, as is known in the art. Keywords for use in the search may be selected according to any desired principles so as to recognize and locate appropriate information from the electronic medical records relating to potential instances of revenue leakage or inpatient comorbidity billing opportunities. For example, the keywords searched may be keywords commonly associated with various diagnosis-related groups (DRGs), keywords potentially implicating various DRGs, keywords associated with various diagnoses, keywords associated with various treatments, keywords associated with various medications, keywords associated with various symptoms, keywords associated with various risk factors, and the like. It should be understood that the term “keyword” embraces single words as well as compound words and defined phrases formed from multiple words.

While keywords may be searched for on an individual basis, keywords may also be searched for using one or more Boolean and other operators. For example, keyword search rules may be established to identify requirements that two keywords be found in the same medical record and/or date of treatment, that two keywords be found within a certain proximity of each other (e.g. within six or ten words of each other), that one keyword be present in a medical record and/or date of treatment but that another keyword not be present or not be present within a certain proximity, and the like. The Boolean and other operators applied to the keyword search may be applied to groupings of two, three, four, or more keywords, as desired, and certain keywords may be present in multiple groupings of search terms so as to be relevant to identification of multiple different types of revenue leakage or inpatient comorbidity billing opportunities.

Permitting the keyword search to be established on the basis of multiple keywords in conjunction can provide certain advantages. For example, some keyword searches that are limited to single keywords or phrases may lead to excessive “false positive” hits not related to revenue leakage or inpatient comorbidity billing opportunities. The use of refined searches contingent on multiple keywords as discussed above may serve to reduce the number of false positive requiring review, thereby reducing the amount of intervention necessary to address revenue leakage problems or inpatient comorbidity billing opportunities.

The method proceeds to decision block 54, where a determination is made as to whether the keyword search has resulted in locating keywords of interest within the database. If not, execution loops to step 52 and the method continues. If, however, one or more keywords of interest have been located in the database, the method continues to a further refinement step at step 56. In this step, a data mining search is conducted in which the system determines if there are any potential modifiers of the located keyword(s) that should be identified as potentially impacting the search results. For example, if the keyword search was directed to the keyword “obesity,” it may be important to know if there is a modifier “no” located immediately preceding the located keyword, as the phrase “no obesity manifested” has significantly different implications than the phrase “obesity manifested,” or the phrase “morbid obesity manifested.”

Once the data mining operation is complete and any relevant modifiers have been identified, the method proceeds to step 58. In this step, the located keyword and any relevant modifiers are used to identify potential unbilled services and/or DRGs. For example, the system may utilize a list of complications and comorbid conditions (CCs) or of major complications and comorbid conditions (MCCs) commonly known to occur in conjunction with the keyword of interest. For example, a medical chart or electronic medical record may have a notation relating to a patient's diabetes or stage of diabetes, but may lack any notations relating to evaluation, diagnosis, or treatment of kidney disease. Kidney disease is a common comorbidity of diabetes, and it would be expected that a medical services provider would at least evaluate the patient for symptoms or effects of kidney disease when treating for diabetes. Similarly, if a patient's medical records show that the patient was treated for heart disease, it is possible or even common that the patient has some level of obesity.

In the given examples, the medical billing coder may have simply failed to properly code for the comorbidities that were indicated in the medical record. In other instances, the medical billing coder may not have known of the comorbidities because no notation was made in the electronic medical records relating to these comorbidities. Embodiments of the invention provide systems and methods for addressing both types of revenue leakage, as will be discussed in more detail below.

The system may use the located keywords and/or modifiers for a variety of purposes while attempting to identify unbilled services and DRGs. For example, the system may use the located keywords and/or modifiers to identify DRGs, CCs and/or MCCs associated with symptoms of the patient recorded in the electronic medical records, to identify DRGs, CCs and/or MCCs associated with diagnoses of the patient recorded in the electronic medical records, to identify DRGs, CCs or MCCs associated with treatments recorded in the electronic medical records, to identify DRGs, CCs and/or MCCs associated with medications administered as recorded in the electronic medical records, and the like. Similarly, the system may use the located keywords and/or modifiers to eliminate DRGs, CCs, and/or MCCs not normally associated with symptoms of the patient recorded in the electronic medical records, to eliminate DRGs, CCs and/or MCCs not normally associated with diagnoses of the patient recorded in the electronic medical records, to eliminate DRGs, CCs or MCCs not normally associated with treatments recorded in the electronic medical records, to eliminate DRGs, CCs and/or MCCs not normally associated with medications administered as recorded in the electronic medical records, and the like.

The system need not be limited to identifying CCs or MCCs commonly occurring together. The system may also take into account any known or defined relationship or relationships between diagnoses, treatments, medications, symptoms, and the like, including preferences of the medical services provider or individual employees of the medical services provider. For example, one or more known or defined relationships may be established between diagnoses and/or treatments, and administration of certain medications. If a medical record indicates that a patient was treated for a broken arm, it might be expected that there is a significant likelihood that the patient also received medication for pain during the treatment of the broken arm. If no billing codes had been identified relating to administration of pain medication, the system could use that information to determine that there is a potential that additional billing could occur.

The system may be able to intelligently determine how to proceed once a potential unbilled item has been identified. Thus, the method proceeds to step 60, where a determination is made as to whether the electronic medical record contains sufficient information to allow for billing for unbilled services and/or DRGs. For example, if the revenue leakage event relates to an error by a medical billing coder, the electronic medical record may have sufficient information relating to the services that were performed but not originally identified by the medical billing coder. In that case, the system could be able to immediately bill for services provided.

In a different example, however, if the revenue leakage event/error occurred on the part of a doctor or nurse who failed to record a diagnosis, symptoms, treatment, services performed, or medication administered, the system may not be able to determine from the medical record standing alone whether the lack of entry in the medical record resulted from an oversight by the person in charge of creating or modifying the medical record or whether the lack of entry in the medical record reflects that services were not provided.

Thus, the method proceeds to decision block 62, where a determination is made by the system as to whether there is information sufficient to allow for billing of unbilled services provided to the patient. If there is sufficient information, the method is able to proceed to step 64, in which the medical service provider bills for the services provided. This may or may not entail involving a medical coder to generate appropriate codes relating to the provided services.

If, however, the electronic medical record lacks sufficient information to permit billing for services potentially provided, the method proceeds to step 66, where the system takes action to confirm whether the identified services were provided (or diagnosis made, symptoms noted, medication administered, etc.). A variety of actions may be taken by the system, such as an action seeking clarification from the employee of the medical services provider who was originally involved with the patient as to whether the identified services were provided. As one example, the system generates and sends an electronic communication to the involved individual requesting clarification regarding whether the services were performed. The electronic communication can be any kind of electronic communication, such as an email, a text or multimedia message, or a message sent through a computer system controlled by the medical services provider.

Such an electronic communication may include a variety of information to assist the employee in identifying whether the identified unbilled services were in fact provided. For example, the electronic communication may include information identifying the patient, a date of providing the known services, the unbilled services (or identified CCs, MCCs, or DRGs related thereto), the services that are known to have been performed, the medical record itself, known diagnoses that are known to have been reached, and any other information that may assist the individual in reviewing the unbilled services to determine whether they were in fact provided and should be billed. The electronic communication may include a request that the individual review the information contained in the electronic medical record and update the medical record as necessary to allow for billing of unbilled services actually performed. In this fashion, feedback is provided to doctors and nurses that assists them in improving the clinical documentation to avoid similar revenue leakage problems in the future.

The system then receives information back from the medical services provider (e.g. its employees in response to the electronic communication) indicating whether the identified unbilled services were or were not provided. Once sufficient confirmation is received, the method proceeds to decision block 68, where a determination is made as to whether the services were in fact provided or not. If yes, the method proceeds to step 64, where the services are billed as discussed above, after which the method ends. If the unbilled services were unbilled because the services were never provided, then the method ends.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A method for minimizing revenue leakage comprising:
accessing a database containing information regarding treatment of a patient by a medical services provider;
conducting a keyword search within the database based on keywords commonly associated with diagnosis-related groups and keywords potentially implicating diagnosis-related groups;
locating a keyword of interest within the database;
conducting a data mining search of words preceding and following the located keyword of interest to identify any modifiers relevant to the located keyword of interest;
using the located keyword and any identified modifiers to identify one or more unbilled diagnosis-related groups associated with the treatment of the patient that has not been billed for by the medical services provider; and
taking an action to facilitate billing of services associated with the one or more unbilled diagnosis-related groups.

2. A method as recited in claim 1, wherein taking an action to facilitate billing of services associated with the one or more unbilled diagnosis-related groups comprises:
using information in the database to confirm that services associated with the unbilled diagnosis-related groups were performed; and
billing for the performed services associated with the unbilled diagnosis-related groups.

3. A method as recited in claim 1, wherein taking an action to facilitate billing of services associated with the one or more unbilled diagnosis-related groups comprises:
generating an electronic communication to the medical services provider requesting clarification of whether services associated with the unbilled diagnosis-related groups were performed; and
sending the electronic communication to the medical services provider.

4. A method as recited in claim 3, wherein the electronic communication comprises information identifying services associated with the one or more unbilled diagnosis-related groups.

5. A method as recited in claim 3, wherein the electronic communication comprises identification of the patient, a date or date range of treatment, and information about one or more treatments known to have been performed, along with identification of one or more treatments commonly performed with the one or more treatments known to have been performed and a request that the provider review whether the one or more treatments commonly performed was performed with the one or more treatments known to have been performed.

6. A method as recited in claim 3, wherein the electronic communication comprises identification of the patient, a date or date range of treatment, and information about one or more diagnoses known to have been identified by the medical services provider, along with identification of one or more diagnoses or treatments commonly performed in conjunction with or identified with the one or more diagnoses known to have been identified by the medical services provider and a request that the provider review whether the one or more diagnoses or treatments commonly performed was identified or performed with the one or more diagnoses known to have been identified by the medical services provider.

7. A method as recited in claim 3, wherein the electronic communication comprises:
identification of a treatment known to have been performed or a diagnosis known to have been identified by the medical services provider; and
identification of one or more complications and comorbid conditions or major complications and comorbid conditions commonly known to occur in conjunction with the treatment known to have been performed or the diagnosis known to have been identified by the medical services provider.

8. A method as recited in claim 1, wherein using the located keyword and any identified modifiers to identify one or more unbilled diagnosis-related groups associated with the treatment of the patient that has not been billed for by the medical services provider comprises:
identifying one or more complications and comorbid conditions or major complications and comorbid conditions commonly known to occur in conjunction with the keyword of interest and any identified modifiers; and
identifying and capturing unbilled diagnosis-related groups associated with any identified comorbid conditions or major complication and comorbid conditions.

9. A method as recited in claim 1, wherein the method is adapted to be conducted behind a firewall to comply with any requirements of the Health Insurance Portability and Accountability Act and to prevent unauthorized disclosure of confidential medical information.

10. A method as recited in claim 1, wherein an identified modifier is used to perform an action selected from the group consisting of:
identifying a complication and comorbid condition comorbid condition associated with a diagnosis reached or treatment performed by the medical services provider;
identifying a major complication and comorbid condition major comorbid condition associated with a diagnosis reached or treatment performed by the medical services provider;
eliminating a comorbid condition not associated with a diagnosis reached or treatment performed by the medical services provider;
eliminating an major complication and comorbid condition not associated with a diagnosis reached or treatment performed by the medical services provider;
identifying a diagnosis-related group associated with a diagnosis reached or treatment performed by the medical services provider; and
eliminating a diagnosis-related group not associated with a diagnosis reached or treatment performed by the medical services provider.

11. A method for reducing revenue leakage comprising:
accessing a database containing electronic medical records of treatment of a patient by a medical services provider;
conducting an automated keyword search within the database based on one or more keywords commonly associated with diagnosis-related groups diagnosis-related group or potentially implicating diagnosis-related group;
locating a keyword of interest within the database;
conducting a data mining search of words preceding and following the located keyword of interest to identify any modifiers relevant to the located keyword of interest;
using the located keyword and any identified modifiers to identify one or more unbilled diagnosis-related groups associated with the treatment of the patient that may potentially be billed for by the medical services provider; and
taking an action to confirm that the unbilled diagnosis-related groups can be billed by the medical services provider.

12. A method as recited in claim 11, wherein taking an action to confirm that the unbilled diagnosis-related group can be billed by the medical services provider comprises:
using information in the database to confirm that services associated with the unbilled diagnosis-related group were performed; and
billing for the performed services associated with the unbilled diagnosis-related group.

13. A method as recited in claim 11, wherein taking an action to confirm that the unbilled diagnosis-related group can be billed by the medical services provider comprises:
generating an electronic communication to the medical services provider requesting clarification of whether services associated with the unbilled diagnosis-related groups were performed; and
sending the electronic communication to the medical services provider.

14. A method as recited in claim 13, wherein the electronic communication comprises information identifying services associated with the one or more unbilled diagnosis-related groups.

15. A method as recited in claim 13, wherein the electronic communication comprises identification of the patient, a date or date range of treatment, and information about one or more treatments known to have been performed, along with identification of one or more treatments commonly performed with the one or more treatments known to have been performed and a request that the provider review whether the one or more treatments commonly performed was performed with the one or more treatments known to have been performed.

16. A method as recited in claim 13, wherein the electronic communication comprises identification of the patient, a date or date range of treatment, and information about one or more diagnoses known to have been identified by the medical services provider, along with identification of one or more diagnoses or treatments commonly performed in conjunction with or identified with the one or more diagnoses known to have been identified by the medical services provider and a request that the provider review whether the one or more diagnoses or treatments commonly performed was identified or performed with the one or more diagnoses known to have been identified by the medical services provider.

17. A method as recited in claim 13, wherein the electronic communication comprises:
identification of a treatment known to have been performed or a diagnosis known to have been identified by the medical services provider; and
identification of one or more complications and comorbid conditions or major complications and comorbid conditions commonly known to occur in conjunction with the treatment known to have been performed or the diagnosis known to have been identified by the medical services provider.

18. A method as recited in claim 1, wherein using the located keyword and any identified modifiers to identify one or more unbilled diagnosis-related associated with the treatment of the patient that may potentially be billed for by the medical services provider comprises:
identifying one or more complications and comorbid conditions or major complications and comorbid conditions commonly known to occur in conjunction with the keyword of interest and any identified modifiers; and
identifying unbilled diagnosis-related groups associated with any identified comorbid conditions or major complication and comorbid conditions.

19. A method as recited in claim 1, wherein the method is adapted to be conducted behind a firewall to comply with any requirements of the Health Insurance Portability and Accountability Act and to prevent unauthorized disclosure of confidential medical information.

20. A method as recited in claim 1, wherein an identified modifier is used to perform an action selected from the group consisting of:
identifying a complication and comorbid condition associated with a diagnosis reached or treatment performed by the medical services provider;
identifying a major complication and comorbid condition associated with a diagnosis reached or treatment performed by the medical services provider;
eliminating a comorbid condition not associated with a diagnosis reached or treatment performed by the medical services provider;
eliminating a major complication or comorbid condition not associated with a diagnosis reached or treatment performed by the medical services provider;
identifying a diagnosis-related group associated with a diagnosis reached or treatment performed by the medical services provider; and
eliminating a diagnosis-related group not associated with a diagnosis reached or treatment performed by the medical services provider.
